(19) United States
(12) Patent Application Publication
(10) Pub. No.: US 2002/0145289 A1
(43) Pub. Date: Oct. 10, 2002

(54) Releasable safety connector

(76) Inventors: Jesse H. Cole, Petersham, MA (US); Thomas W. Chase, Laconia, NH (US)

Correspondence Address: KEVIN ELLICOTT, Esq., 31 GREEN SQUARE, PROCTOR, VT, 05765, US

(21) Appl. No.: 09/826,226

(22) Filed: Apr. 4, 2001

(51) Int. Cl. E05C 5/04

(52) U.S. Cl. 292/58

(57) ABSTRACT

A releasable safety connector having a mid-section spanning between a first leg and a second leg, the first leg and second leg being tangentially opposed to one another and biased toward one another, the releasable safety connector being mountable between a top retainer plate and a bottom retainer plate for use in a releasable securing mechanism and being made adjustable through the incorporation of an adjustable force bar.

### CROSS REFERENCE TO OTHER APPLICATIONS

This is the first submission of an application for this article of manufacture. There are no other applications, provisional or non provisional.

### FEDERALLY SPONSORED RESEARCH AND DEVELOPMENT

There are no federally sponsored or funded research or development projects or undertakings in any way associated with the instant invention.

### BACKGROUND OF THE INVENTION

1. Field of the Invention

The instant invention relates to that field of devices consisting of articles of manufacture known as releasable links and connectors. Specifically, the instant invention is a releasable safety connector configured for securing animals and animal stall doors, yet releasing when sufficient force is applied.

2. Background Information

The prior art known to the Inventors discloses that various forms of releasable connector devices useful in securing animals and animal stall doors are well known. Such devices generally include at least two components being held together using various types of biasing means which, when sufficient tension or force is applied to one of the components, will come apart, thereby releasing the tension and freeing the animal or door.

These prior art devices are generally utilized to secure an animal so that it cannot easily escape, but at the same time provide a controlled means for release of the animal in case of an emergency. For example, horses are frequently tethered, tied or otherwise secured in a barn stall using securing means such as a leather strap or rope which is tied at one end to the horse's halter and at the other end to a wall mounted ring or other firmly affixed attachment means. While so secured, the animal is prevented from easily escaping the stall. However, situations arise wherein it may in fact be desirable for the animal to be able to break free of the securing means and escape the stall.

Keepers of horses and other such large livestock are keenly aware of the many dangers which face animals who are secured while penned or stalled. Every year many horses perish in barn fires because they are unable to break free of their securing means and cannot escape from their locked stall. Animals secured while in an outdoor pen have been known to be killed by snakes, other animals and other extreme conditions when they were unable to break free of their securing means and escape the threat. Furthermore, horses and other livestock have been killed while being transported in enclosed livestock trailers when those trailers were involved in motor vehicle accidents and the animals could not pull free of their securing means nor force open the closed trailer door. The instant invention provides a means for avoiding these and many other potentially deadly situations.

An additional concern noted in the prior art is that it is frequently desirable to “hobble” or otherwise restrict the movement of a horse or other livestock while performing various tasks upon the animal. For example, it is well known that having a horse secured while shoeing or otherwise attending to the hooves of the animal is greatly desirable. However, in the event that the animal becomes “spooked” or otherwise panicked, such securing can lead to severe injuries to both the animal and the human working upon the animal. These injuries may be avoided by simply providing the animal with the ability to break free of its securing means and giving the animal the opportunity to calm down before re-engaging in the activity. Prior art devices have long recognized the desirability of providing an escape means to these panicked animals. The instant invention in fact provides a controlled escape means that may be easily varied to suit the size and weight of the animal under various conditions.

Prior art devices known to the Inventors often require the user of the device to set the release tension prior to use. An example of such a device may be found in U.S. Pat. No. 5,771,843, “Break-Away Tie Apparatus For Securing Animals” issued to William C. Karlin on Jun. 30, 1998. The Karlin '843 patent utilizes a tubular chamber within which a pair of oppositely aligned spring biased gripping members are located. A lateral bore through the tubular chamber permits a spherical mounting portion having an attached stem and ring portion to be inserted into the tubular chamber between the biased gripping members. When sufficient pulling force is applied to the ring portion, the mounting portion may be pulled free from between the gripping members.

Unfortunately, the gripping members must be manually adjusted by a user in order to vary the force required to pull the mounting portion free of the gripping members. Determining the amount of force so required becomes a grueling exercise of trial and error, requiring much time and effort. Furthermore, re-inserting the mounting portion into the tubular chamber, between the gripping members is a difficult task as the mounting portion, because of its spherical configuration, has a tendency rotate as force is applied rather than simply slide between the gripping members. This can result in frustration and bloody knuckles for the user trying to reassemble the device after it has been pulled apart.

A final issue presented by the prior art is that safety releases generally include many individual moving parts. These interdependent (and frequently complex) parts are often exposed to not only the elements (such as rain and snow) but also come into direct contact with mud, dirt, hay and other unwanted intrusive materials. These unwanted intrusive materials tend to enter the mechanisms of prior art safety releases and at the least, reduce the efficiency of the devices, and at the worst ruin the devices so that they no longer function as intended.

### SUMMARY OF THE INVENTION

The instant invention is a releasable safety connector or panic release device intended to be utilized in securing animals and animal stall doors. The Ultracite Escape Mechanism, as the instant invention is known to the Inventors, in the preferred embodiment, is constructed from a metal rod which is bent such that it has a midsection having extending therefrom two opposing, tangentially disposed and preferably co-planar legs. The midsection and tangentially opposed legs together result in a device which is self biasing, that is, the tangentially opposed legs are biased towards one another and require the application of force to spread them apart from one another.

A first object of the instant invention is to require no experimentation on the part of a user in order to prepare the releasable safety connector prior to use. The instant invention differs from the prior art in that it is pre-fabricated using known release tensions based upon rod thickness and composition, length of arms and midsection configurations. There is no need to engage in a process of trial and error when setting spring tensions or determining release values.

Use of the instant invention requires only the releasable safety connector and at least one (preferably two) releasable connector means such as release snaps, release rings, snap hitches or the like. Having chosen the releasable safety connector appropriate for the weight of the animal to be secured and the use to which it will be put, the user of the instant invention merely attaches a the animal to be secured to a releasable connector (for example, by tying or lashing the animal's halter to the release snap) and then attaches the release snap to the releasable safety connector midsection. Next, the user attaches a releasable connector to the structure to which the animal is to be secured (for example, by tying, lashing, or bolting) and then attaches the releasable connector around one of the releasable safety connector legs such that the releasable connector passes through the space between the releasable safety connector legs.

A further object of the instant invention is to minimize the opportunity for dirt and other unwanted intrusive materials to reduce the device's efficiency. The instant invention accomplishes this objective by minimizing structures which are likely to become fouled during use. The instant invention further differs from the prior art in that unlike the prior art, the instant invention does not include myriad moving parts which are likely to become damaged by the elements or so clogged with unwanted intrusive materials that it no longer functions as intended.

Another object of the instant invention is to provide a releasable safety connector which can be adapted to use on barn, stall, and corral doors and gates. This objective is accomplished with another embodiment of the instant invention in which the releasable safety connector is mounted between two rectangular plates, the rectangular places each having an essentially “U” shaped cutout. The combination plates/releasable safety connector may then be firmly attached to a barn or stall door. A standard sliding locking bolt may then be attached to the adjacent door post such that when the bolt is in it's locked position, it extends between the two safety release legs.

Those familiar with horses are well aware that they are intelligent animals which can be trained relatively easily. The Inventors have learned that it is possible to train these (and other) animals to knock the barn or stall door open once the safety release is in place. This is accomplished by training the animal with safety releases which require minimal amounts of force in order to open. Training in this manner continues by substituting safety releases requiring greater and greater amounts of force in order to open. It has been further learned that while a particular safety release requires more force to open it than the animal will generally exert in order to escape the enclosure, when faced with a situation in which the animal panics, the animal will exert far greater force. Therefore, after minimal training it is possible for the animal to escape a life threatening hazard while at the same time keeping the animal secured during non-threatening conditions.

A further object of the instant invention is to provide a means for user adjustment of the device such that the force required to overcome the self-biasing of the tangentially disposed legs may be quickly and easily modified.

This object is accomplished through another embodiment of the instant invention wherein the midsection has extending therefrom a pair of straight leg extensions, between the midsection and the tangentially disposed legs, and an adjustable force bar mounted on the straight leg extensions. The adjustable force bar may be moved toward the midsection, reducing the force required to overcome the biasing of the tangentially disposed legs, or moved toward the tangentially disposed legs, thus increasing the force required to overcome the biasing of those legs.

### A DESCRIPTION OF THE DRAWINGS

FIG. 1 is a plan view of the first embodiment of the releasable safety connector.

FIG. 2 is a perspective view of the first embodiment of the releasable safety connector.

FIG. 3 is a partial cross sectional view of the first embodiment of the releasable safety connector.

FIG. 4 is a partial cross sectional view of the first embodiment of the releasable safety connector.

FIG. 5 is a plan view of an embodiment of the releasable safety connector.

FIG. 6 is a partial cut away perspective view of an embodiment of the releasable safety connector.

FIG. 7 is a perspective view of a more complex stand off.

FIG. 8 is a plan view of the more complex stand off.

FIG. 9 is a perspective view of another embodiment of the releasable safety connector being used to latch a door.

FIG. 9 is another perspective view of the releasable safety connector being used to latch a door.

FIG. 11 is perspective view of a spacer means.

FIG. 12 is a perspective view of the bottom retainer plate of the another embodiment of the releasable safety connector.

FIG. 13 is a perspective view of the same bottom retainer plate along with the releasable safety connector.

FIG. 14 is a perspective view of the top retainer plate of another embodiment of the releasable safety connector.

FIG. 15 is a side elevational view of the bottom retainer plate and top retainer plate of the same embodiment of the releasable safety connector.

FIG. 16 is a perspective view of a simple stand off.

FIG. 17 is another perspective view of the simple stand off.

FIG. 18 is a close up partial perspective view of the releasable safety connector and retainer ring.

FIG. 19 is a close up partial perspective view of the releasable safety connector first leg and second leg.

FIG. 20 is a perspective view of the releasable safety connector restraining a horse.

FIG. 21 is a perspective view of the releasable safety connector in use.

FIG. 22 is a close up partial perspective view of the releasable safety connector and snap hitch.

FIG. 23 is a close up partial perspective view of the releasable safety connector and snap hitch.

FIG. 24 is a close up partial perspective view of the releasable safety connector and snap hitch.

FIG. 25 is a side view of the third embodiment attached to a suitable mounting area.

FIG. 26 is plan view of the third embodiment and door latch.

FIG. 27 is a perspective view of the third embodiment cooperating with the door latch.

FIG. 28 is a close up plan view of the bolt cooperating with the first and second leg.

FIG. 29 is a close up plan view of the bolt cooperating with the first and second leg.

FIG. 30 is a close up plan view of the bolt, first leg and second leg.

FIG. 31 is a close up side view of a bolt with latch retention means engaging another embodiment of the releasable safety connector.

FIG. 32 is a perspective view of a portion of a latch incorporating the releasable safety connector.

FIG. 33 is a side view of the releasable safety connector mounted between a pair of plates.

FIG. 34 is a side elevational view of the releasable safety connector mounted atop more complex stand offs.

FIG. 35 is a perspective view of the releasable safety connector being assembled onto the more complex stand offs.

FIG. 36 is a side elevational view of the releasable safety connector mounted atop the more complex stand offs and a latch spacing plate.

FIG. 37 is a perspective view of another embodiment of the releasable safety connector incorporating an adjustable force bar.

FIG. 38 is an elevational view of a two piece adjustable force bar.

FIG. 39 is a side cross sectional view of the two piece adjustable force bar incorporating tabs.

FIG. 40 is an overhead plan view of the releasable safety connector incorporating grooves and the adjustable force bar.

FIG. 41 is another overhead plan view of the releasable safety connector incorporating grooves and the adjustable force bar.

### A DESCRIPTION OF THE PREFERRED EMBODIMENT

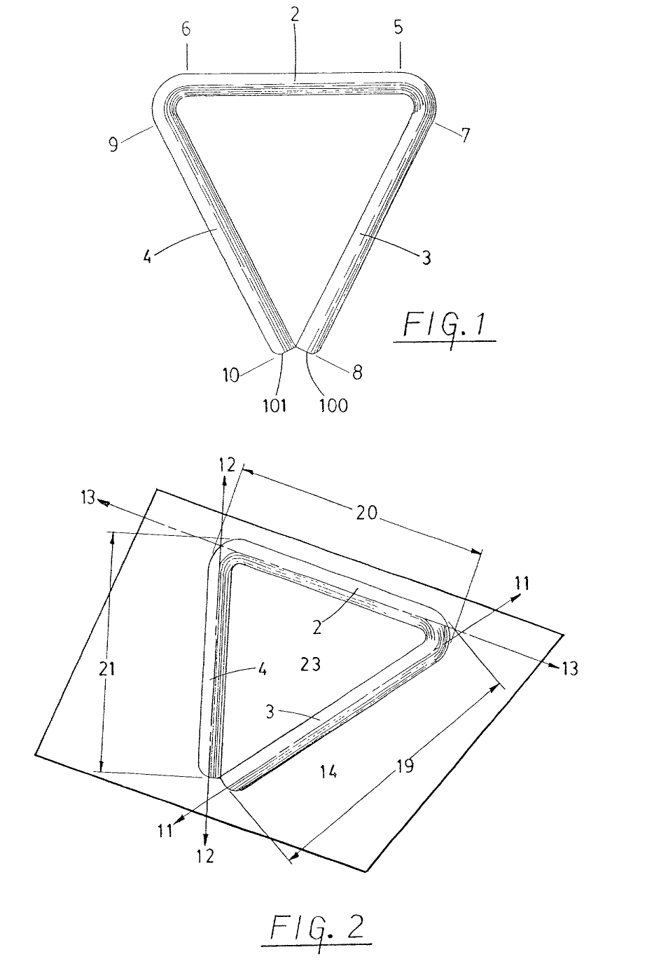

As per FIG. 1, in the preferred embodiment the instant invention is a releasable safety connector (1) having a first leg (3), a second leg (4) and a leg intermediate means (2) to which the legs are each attached. In the preferred embodiment of the releasable safety connector, the first leg (3) and the second leg (4) are tangentially opposed to, but not attached to and biased towards, one another.

In a first embodiment, the Inventors prefer the releasable safety connector to be constructed from a single metal rod which is bent into an essentially triangular form. In this embodiment, the leg intermediate means is a midsection having a first end (5) and a second end (6). The first leg (3) has a first end (7) and an opposite second end (8), the first end (7) merging into and becoming one with the midsection first end (5). The second leg (4) has a first end (9) and an opposite second end (10), the first end merging into and becoming one with the midsection second end (6).

As per FIG. 2, the first embodiment may be better understood by noting that the metal rod from which the device is constructed is essentially tubular in form. Therefore, once bent into its nearly triangular configuration, the first leg (3) may be described as having a longitudinal axis (11), the second leg (4) may be described as having a longitudinal axis (12) and the midsection (2) may be described as having a longitudinal axis (13). In the preferred embodiment, the first leg longitudinal axis (11), the second leg longitudinal axis (12) and the midsection longitudinal axis (13) are all horizontally co-planar in a first horizontal plane (14).

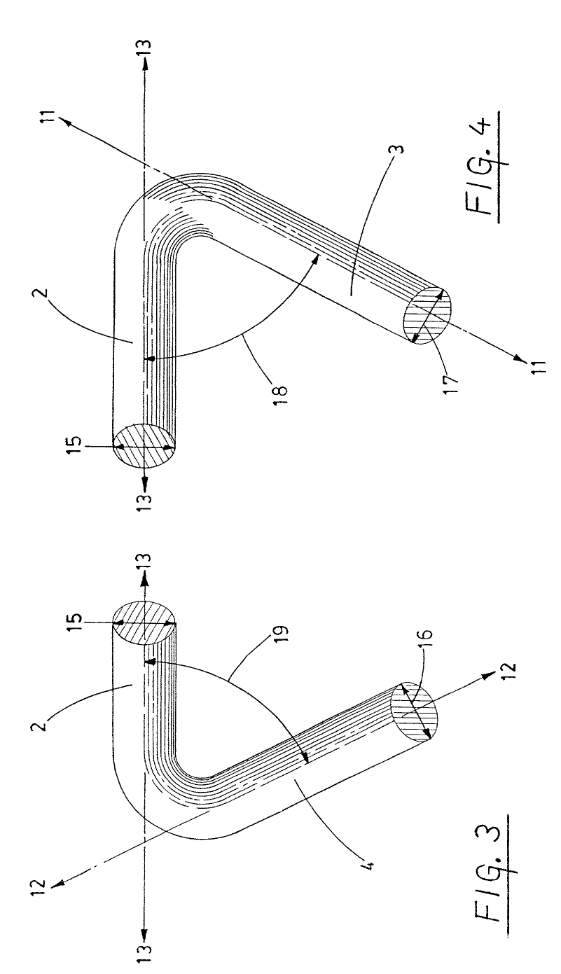

As per FIGS. 1, 3 and 4, the midsection (2) has a midsection has a diameter (15), the second leg (4) has a diameter (16) and the first leg (3) has a diameter (17). In the first embodiment, the midsection diameter (15), the first leg diameter (17) and the second leg diameter (16) are equal to one another. The midsection diameter is preferred to be approximately 1/3 of one inch.

It should be further noted that the second leg first end (9) and the midsection second end (6) are attached to one another such that the second leg (4) and the midsection (2) are tangentially opposed to one another. Furthermore, the first leg first end (7) and the midsection first end (5) are attached to one another such that the first leg (3) and the midsection (2) are tangentially opposed to one another. The Inventors refer to the portion of the first leg second end which is most distal from the midsection as the first leg terminating portion (100). The portion of the second leg second end which is most distal from the midsection is referred to as the second leg terminating portion (101). In the first embodiment, the first leg longitudinal axis (11) and the midsection longitudinal axis (13) intersect one another such that an approximately 72 degree first angle (18) is formed therebetween. Furthermore, the second leg longitudinal axis (12) and the midsection longitudinal axis (13) intersect one another such that an approximately 72 degree second angle (19) is formed therebetween. Naturally, the axis angles relative to one another are provided merely to assist those skilled in the art in practicing the invention without engaging in undue experimentation. These angles may easily be modified, thus changing the pressure required to overcome the self-biasing, without in any way departing from the scope of claims which follow. For example, one could easily decrease the length of the legs, increase the angles stated above, and thereby require additional force in order to spread apart the legs (even assuming identical materials and material thickness). Or, one might increase the length of the legs, decrease the angles and thereby require less force in order to spread apart the legs.

It is important to understand that, while this embodiment of the instant invention has been thus far described as including a midsection having extending therefrom a first leg and a second leg, the legs being tangentially opposed to one another, it would be possible to configure the releasable safety connector in other equivalently operational ways. So long as the legs are tangentially opposed to one another, and biased toward one another, the leg intermediate means may be embodied in a wide variety of ways. A non-limiting example would be physically separate element such as a metal plate or retainer ring to which the legs could be attached (for example, by welding). In such a case, the metal plate or ring would be equivalent to the leg intermediate means.

It should be further understood, as per FIG. 2, that in the first embodiment the first leg (3) has a length (19), the midsection (2) has a length (20) and the second leg (4) has a length (21). Furthermore, the first leg (3), midsection (2) and second leg (4) form the periphery of an open inner space (23). The first leg length is preferred to be approximately 4 and 1/2 inches, the second leg length to be 4 and 1/2 inches, and the midsection length to be approximately 2 and 1/2 inches. Obviously, these measures may be easily modified in keeping with the instant invention and need not be followed literally.

It has been noted that the first leg first end is attached to the midsection first end and that the second leg first end is attached to the midsection second end. The first leg terminating portion (100) is proximate to, though not attached to, the second leg terminating portion (101). It is preferred that the first end terminating portion and the second end terminating portion not be in contact with one another, however, contact will not impede the operation of the invention.

Naturally, the dimensions given above are merely for purposes of a fully enabling disclosure, and are not intended as requirements. These dimensions may easily be varied according to need without departing from the scope of the claims which follow.

The disclosure of the first embodiment of the instant invention serves as an extremely basic design upon which various additional embodiments are now presented.

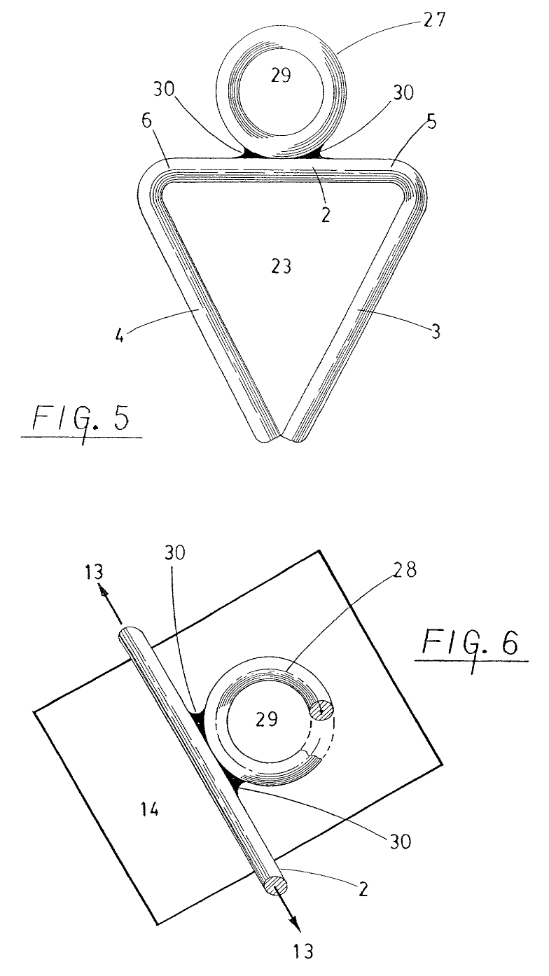

As per FIGS. 5 and 6, in the second embodiment, the releasable safety connector has a midsection (2), a first leg (3) and a second leg (4) which are identical in form and construction to the first embodiment. In the second embodiment, however, the midsection (2) has attached thereto a connector means such as a retainer ring (27), the retainer ring being torus shaped in form, that is, what is known in the literature as an “anchor ring” type torus having a single hole, and having a ring axis (28) which is co-planar with the first leg longitudinal axis, the second leg longitudinal axis and the midsection longitudinal axis. By virtue of its torous shape, the retainer ring (27) further defines an open center (29) (the torus' hole). The open center ideally has an inner diameter of approximately 1 inch. The retainer ring should be permanently attached to the midsection approximately midway between the midsection first end (5) and the midsection second end (6). Weld joints (30) are the preferred attachment means for attaching the retainer ring (27) to the midsection, however any other permanent attachment means would serve equally well.

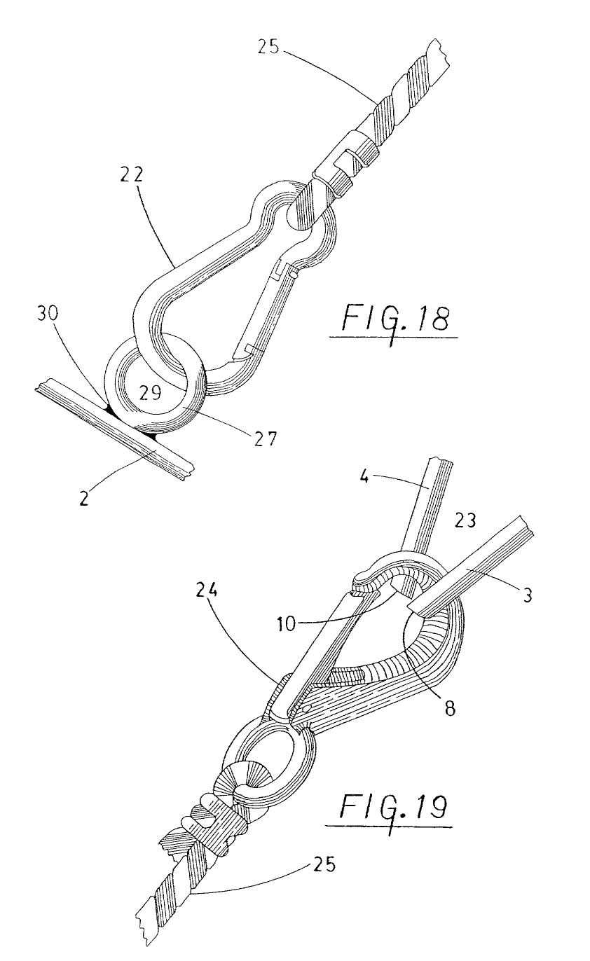

The operation of the second embodiment of the instant invention may now be better understood. As per FIGS. 18 and 20, the releasable safety connector is used in conjunction with preferably a pair of releasable connectors. For purposes of explanation, the use of the device is described when utilizing a pair of snap hitches. A first snap hitch (22) is opened sufficiently such that it may be hooked onto the releasable safety connector, passing around the retainer ring (27) and into the retainer ring open center (29). The first snap hitch (22) is then closed, thereby securely fastening it to the releasable safety connector. Obviously, though the operation of the second embodiment as thus far described incorporates as the connector means a retainer ring, other connector means having the same function could easily be substituted. By way of non-limiting example, one could just as easily substitute a connector means which is a “U” shaped rod, the open end of the “U” being attached to the midsection so as to provide an open center through which the releasable connector could be attached.

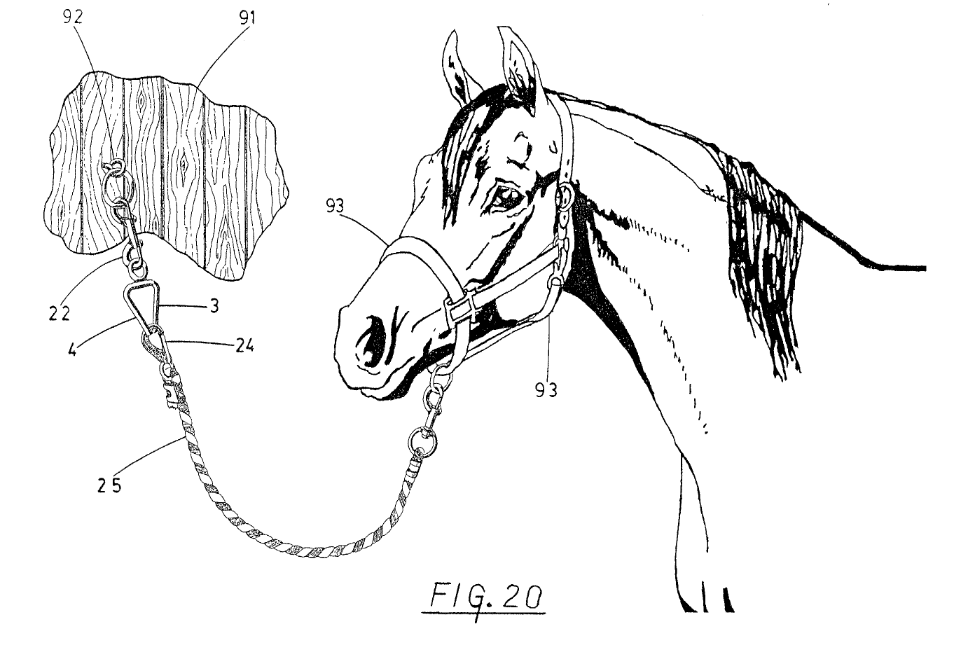

As per FIGS. 19 and 20, the process is repeated with a second snap hitch (24), the second snap hitch being opened and passed around either the first leg (3) or the second leg (4) and through the open inner space (23). The second snap hitch is then closed, the second snap hitch being aligned oppositely from the first snap hitch.

As per FIGS. 18, 19 and 20, the first snap hitch (22) and the second snap hitch (24) both have attached thereto a rope, cord or other securing line means (25). As per FIG. 20, the securing line means attached to the first snap hitch may be attached to a wall, hitching post or other suitable securing location (91). This may be most easily accomplished by attaching the securing line means to suitable anchoring means (92) such as an eye bolt. The second snap hitch (24), in turn, is attached to a securing line means (25), the securing line means then being attached to an animal restraining means (93) such as a halter. Thus, the animal is secured to whatever securing location the user wishes, with the instant invention serving as the releasable safety connector between the securing location (91) and the animal's restraining means (93).

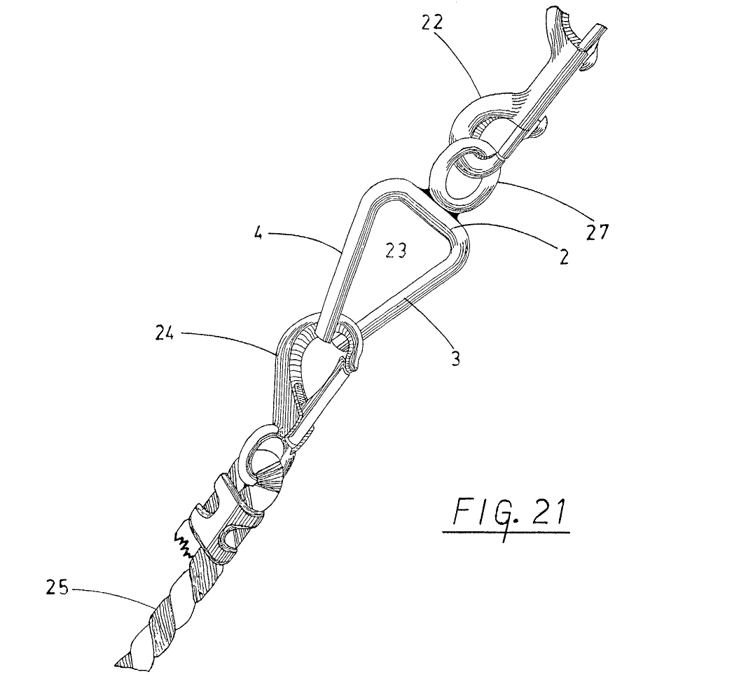

As per FIG. 21, when an animal which is restrained with the instant invention attempts to pull free from the securing location, the securing line means are pulled taunt. If the animal continues to pull away from the securing location, the second snap hitch (24) is pulled away from the first snap hitch (22), and the second snap hitch lodges in direct contact with the first leg (3) and the second leg (4), proximate to the terminating end of the first leg and the second leg.

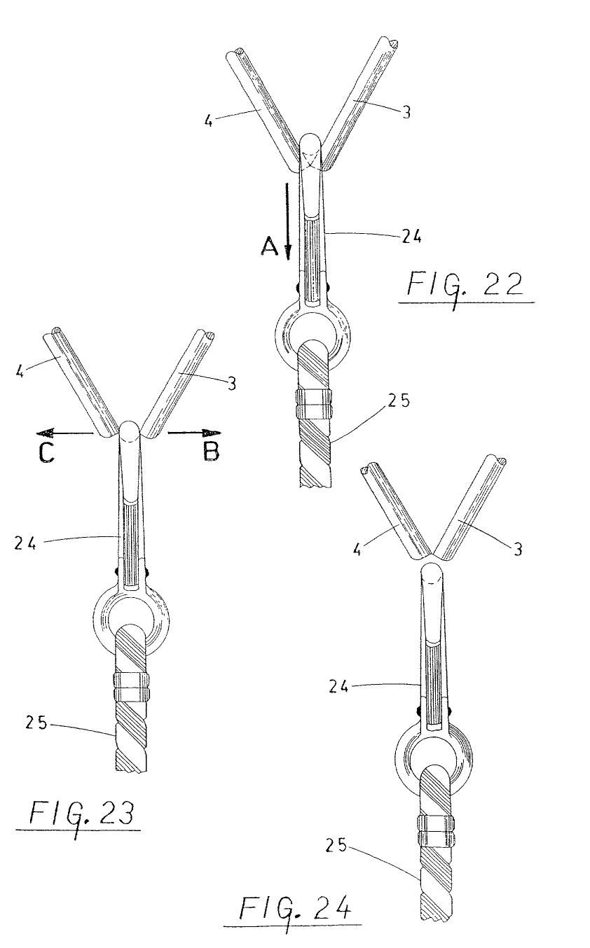

As per FIGS. 22, 23, and 24, if the animal continues to pull away from the securing location, the second snap hitch moving in the direction of arrow “A” (away from the midsection), the second snap hitch will wedge between the first leg (3 and the second leg (4). Should the animal continue to pull away from the securing means, the second snap hitch will force the first leg (3) and the second leg (4) apart from one another, the first leg being forced in the direction of arrow “B” and the second leg being forced in direction of arrow “C”. It should be noted that when forced apart in this fashion, the first leg and the second leg will remain in the first horizontal plane (though if a configuration of the first leg and the second leg is chosen in which the first leg longitudinal axis and the second leg longitudinal axis are not horizontally coplanar in the at rest position, then as the legs are wedged apart from one another they will not remain horizontally coplanar).

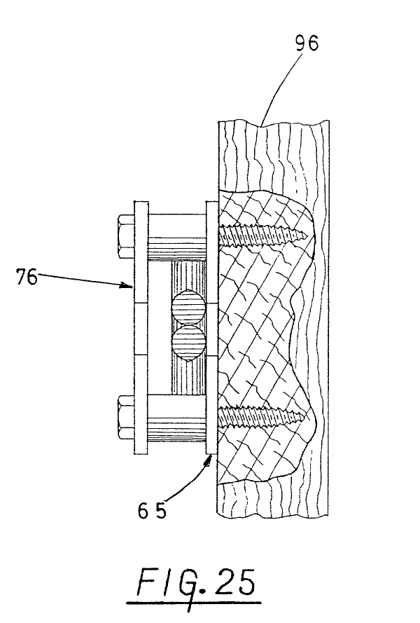

Finally, if the animal exerts sufficient force while pulling away from the securing location, the first leg (3) and the second leg (4) will be wedged apart by the second hitch (24) sufficiently to permit the still closed second hitch to pull free of the releasable safety connector, thereby releasing the animal from the securing location. As per FIG. 24, when the second hitch is pulled free of the releasable safety connector, the first leg (3) and the second leg (4) will return to their original position self-biased position, and the device is once again ready for reattachment of the second hitch.

It should be noted that the first embodiment functions nearly identically to the second embodiment, the only difference being that the first hitch is attached directly onto the midsection (2), rather than onto the retainer ring.

It should also be noted that while the first leg, second leg, and midsection were described in the first embodiment as being horizontally coplanar with one another, it is not a requirement. The could in fact be axially offset from one another in order to modify the force required to overcome the self-biasing of the legs. Furthermore, while the first and second embodiments set forth the instant invention as being essentially “triangularly” shaped, this not a requirement either. The midsection and legs together could take a great variety of shapes. By way of non-limiting examples, one could easily configure the midsection and legs to take the form of a nearly “diamond” shape merely by bending the midsection in a “V” shape. Or one might incorporate the retainer ring directly into the midsection. One simple way to accomplish this would be to utilize the bent midsection as described immediately above, and at the bend to introduce a “U” shaped portion. Other easily imaginable configurations include an “arc” shaped midsection with straight legs, and an arc shaped midsection with legs which were arc shaped too, resulting in an overall appearance of an oval releasable safety connector. As with the preferred embodiment, all that is required is that the legs are biased toward one another such that whatever means shall be used to connect to the releasable safety connector must require force in order to separate the legs from one another in order for that means to be pulled free from the releasable safety connector.

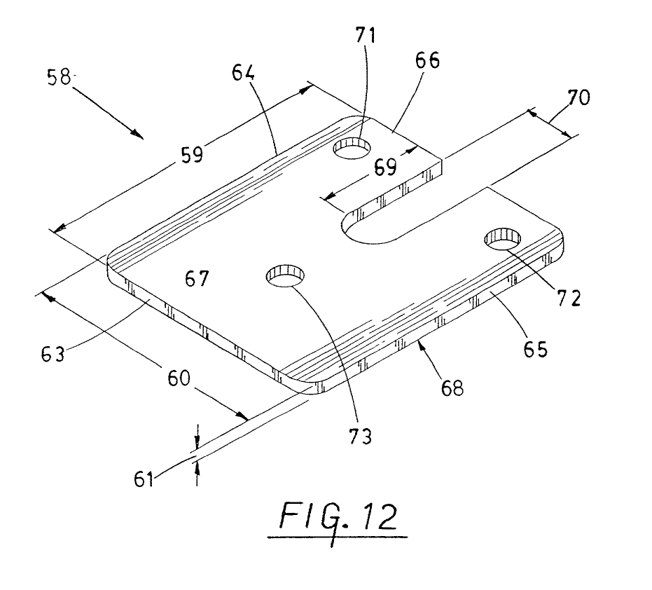

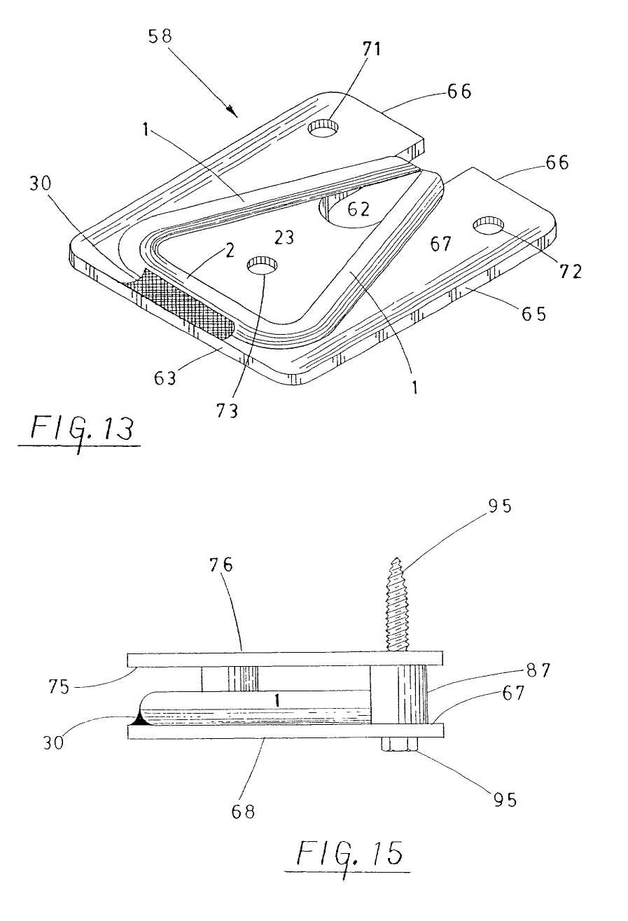

In another embodiment, as per FIGS. 12 and 13, the releasable safety connector as described in the first embodiment as per FIGS. 1, 2, 3 and 4 is mounted between a bottom retaining plate and a top retaining plate in order to be useful as a releasable securing mechanism on doors and gates, preferably the sort of door and gate which pivots or swings open and closed.

As per FIG. 12, the bottom retaining plate (58) having bottom retaining plate length (59), bottom retaining plate width (60) and bottom retaining plate thickness (61) is fashioned from a substantially hard and inflexible material such as steel. It is preferred that the bottom retaining plate be rectangular in form, having a first side (63), a second side (64), a third side (65) a fourth side (66), a top surface (67) and a bottom surface (68), the first side (63) being parallel to the fourth side (66) and perpendicular to the second side (64) and the third side (65), the third side (65) being parallel to the second side (64) and perpendicular to the first side (63) and the fourth side (66), the top surface (67) and the bottom surface (68) being parallel to, though not co-planar with one another, and being perpendicular to the first side (63), the second side (64) the third side (65) and the fourth side (66).

The bottom retaining plate further has a slot (62) preferably passing through the fourth side (66), the slot having slot length (69) and slot width (70). The slot (62) is preferred to be a generally “U” shaped cut out passing completely through the top surface (67) the bottom retaining plate thickness (61) and the bottom surface (68), although a semi-circular, square, triangular, oval, or rectangular shaped cut-out would work equally well.

The bottom retaining plate further has retainer holes passing completely through the top surface (67) the bottom plate thickness (61) and the bottom surface (68) which allow an object such as a screw, bolt, nail or the like to be passed completely through the bottom retaining plate. The Inventors prefer to utilize a first retainer hole (71), a second retainer hole (72) and a third retainer hole (73), the first retainer hole (71) being located proximate to the second side (64) and the fourth side (66), about midway between the slot (62) and the second side (64). It is preferred to locate the second retainer hole (72) proximate to the third side (65) and the fourth side (66), about midway between the slot (62) and the third side (65). It is preferred to locate the third retainer hole (73) approximately equidistantly between the second side (64) and the third side (65), and nearly equidistantly from the slot closed end (74), the slot closed end being that portion of the slot most proximate to the first side (63).

The releasable safety connector, as described in the first embodiment, is in this embodiment permanently attached to the top surface of the bottom plate as per FIG. 13. The Inventors generally use a weld joint (30) to securely fasten the midsection (2) of the releasable safety connector to the top surface (67) of the bottom retaining plate such that the midsection (2), the first leg (3) and the second leg (4) are in direct contact with the bottom retaining plate top surface (67). It is further preferred to permanently attach the releasable safety connector (1) to the bottom retainer plate such that the terminating portion of the first leg second end (8) and the terminating portion of the second leg second end (10), the terminating portion of each leg being that portion most distal from the midsection (2), are adjacent to and overlying the slot (62), extending in the general direction of the fourth side (66).

As per FIG. 14, the releasable safety connector is sandwiched between the bottom retainer plate and the top retainer plate. The top retainer plate (77) is identical to the bottom retainer plate, having exactly the same form and configuration as the bottom retainer plate. The top retainer plate has top retainer plate length (78), top retainer plate width (79), top retainer plate thickness (80), a top retainer plate slot (81), the top retainer plate slot having top retainer plate slot length (82) and top retainer plate slot width (83), and top retainer plate retainer holes, preferably a top retainer plate fourth hole (84), a top retainer plate fifth hole (85) and a top retainer plate sixth hole (86). When fully assembled, the top retainer plate bottom surface (75) is adjacent to the releasable safety connector (1), the top retainer plate bottom surface (75) and the bottom retainer plate top surface (67) facing one another, parallel to one another, though not coplanar with one another. It is preferred that the top retainer plate length (78) is approximately 3 inches, the top retainer plate width (79) is approximately 2 and 1/2 inches and the top retainer plate thickness (80) is approximately 1/8 of one inch, though these measures are clearly not necessary for the device to function.

It has been learned that in order for the third embodiment to operate at peak efficiency, the top retainer plate bottom surface ought not be in direct contact with the releasable safety connector. Therefore, as per FIGS. 14 and 15, stand offs are utilized which are also sandwiched between the top retainer plate and the bottom retainer plate, the stand offs being in direct contact with both the top retainer plate bottom surface (75) and the bottom retainer plate top surface (67).

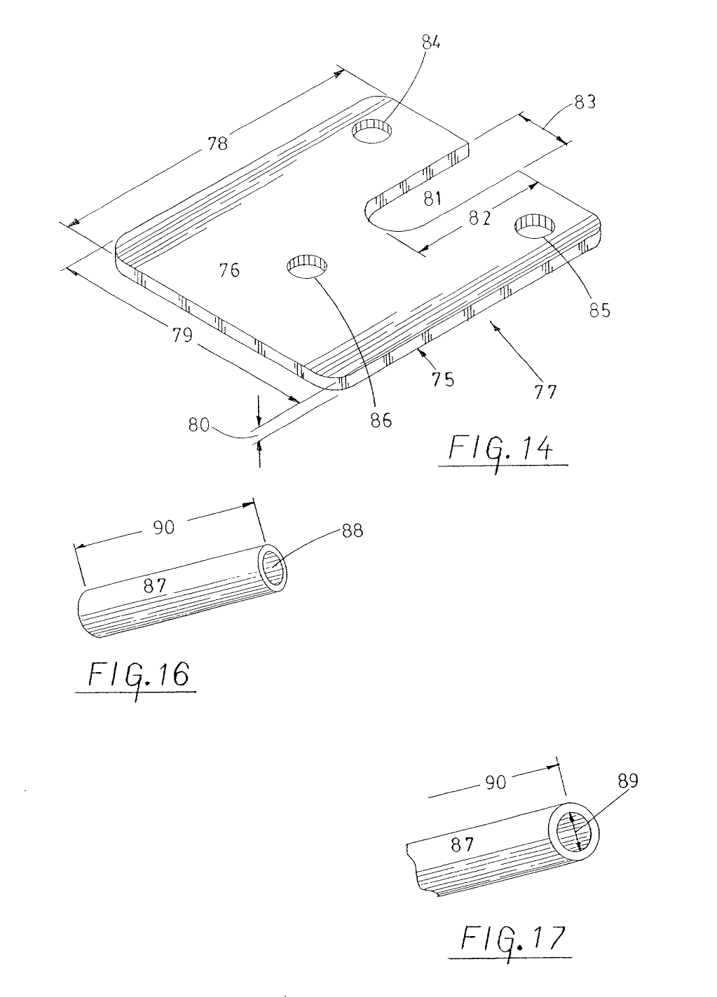

As per FIGS. 15, 16, and 17, one may utilize simple stand offs (87) which are essentially a hollow tube or cylinder having a hollow interior passage (88), the hollow interior passage having hollow interior passage diameter (89), the stand offs further having stand off height (90). The stand off hollow interior passage diameter (89) is preferred to be approximately 1/4 of one inch, however, this may be increased or decreased so long as the diameter is sufficient to permit the passage therethrough of a plate attachment means (95), the plate attachment means preferably being a screw having sufficient length to pass through the bottom retainer plate and the top retainer plate (once assembled together with the safety release connector and the stand offs) and securely attach the entire assembly to a stall doorway or other suitable attachment area.

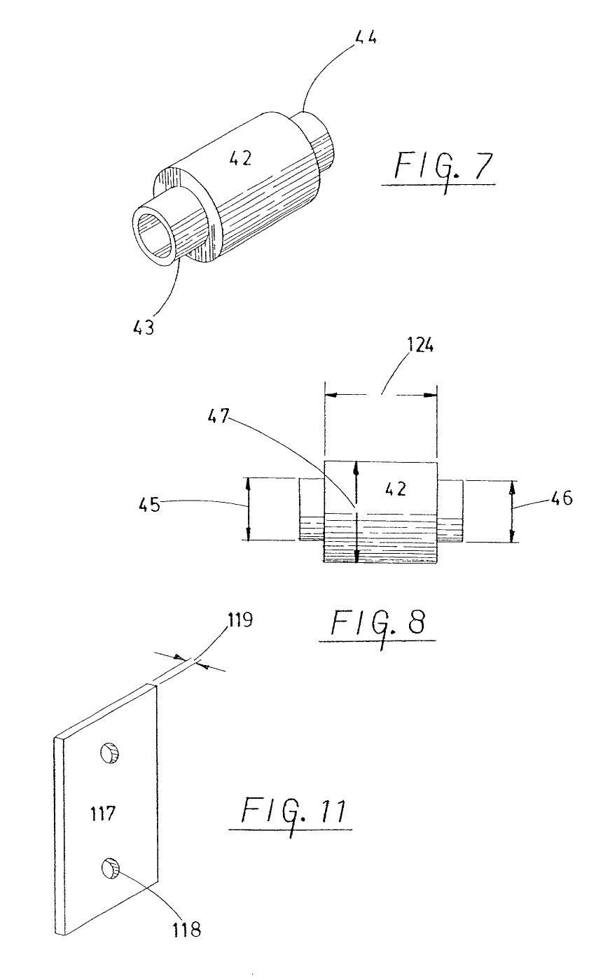

While the simple stand off may be used to ensure a spacing apart of the bottom and top retainer plates, one may just as easily use other forms, such as, but not limited to, more complex stand offs (42) as per FIGS. 7 and 8. Such more complex stand offs could be similar to the simple stand off, but also include a first shouldered section (43) and an opposite second shouldered section (44). The first shouldered section and second shouldered section are merely sections of the more complex stand off having an exterior diameter (45)(46) measuring less than the exterior diameter of the midsection (47).

When assembled as described above, as per FIGS. 12, 13, 14 and 15, and using the simple stand offs, three stand offs are utilized, the first stand off being attached to the top retainer plate bottom surface (75) such that it is coaxial with the top retainer plate fourth hole (84), the second stand off being attached to the top retainer plate bottom surface such that the second stand off is coaxial with the top retainer plate fifth hole (85), and the third stand off being attached to the top retainer plate bottom surface such that the third stand off is coaxial with the top retainer plate sixth hole (86). The Inventors believe that it is best to permanently attach the stand offs to the top retainer plate, however this is not necessary. When the stand offs are permanently attached to the top retainer plate, it has been found that utilization of a weld joint (30) to accomplish that attachment is most satisfactory.

As was noted above, the stand offs are utilized to ensure that the top retainer plate bottom surface (75) is not in direct contact with the safety release connector. It has been learned that this permits the safety release connector operate more efficiently by limiting the frictional contact of the top retainer plate with the safety release connector. It should be clear that in order for this to be accomplished, the stand off height (90) should be greater than the midsection diameter (15), the first leg diameter (17) and the second leg diameter (16). It should also be clear that the first retainer hole (71), second retainer hole (72), third retainer hole (73), fourth retainer hole (84), fifth retainer hole (85) and sixth retainer hole (86) should be sufficiently large in terms of diameter so as to permit the passage therethrough each of the plate attachment means (95).

It is now possible to describe the operation of the third embodiment of the instant invention. The bottom retainer plate (58) having attached thereto the releasable safety connector (1) and the stand offs (87) is connected to the top retainer plate (77) by passing one plate attachment means (95) through the first retainer hole (71), and fourth retainer hole (84), one plate attachment means (95) through the second retainer hole (72) and the fifth retainer hole (85) and one plate attachment means (95) through the third retainer hole (73) and the sixth retainer hole (86).

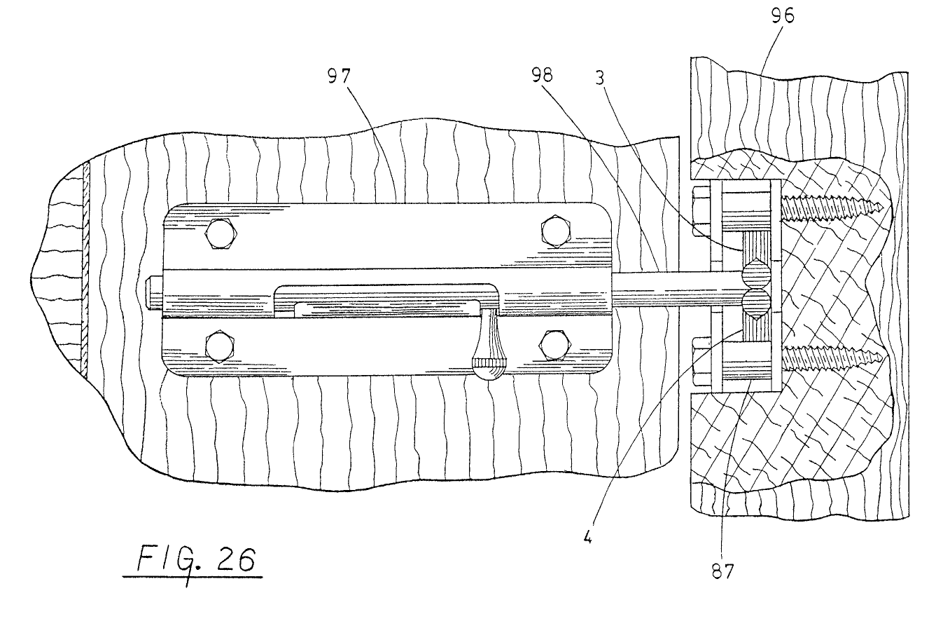

As per FIG. 25, the instant invention is attached to a suitable mounting area (96) by the attachment means (95). The Inventors prefer to utilize the barn stall door jamb when the instant invention is to be used on a barn stall. When used in this manner, the bottom retainer plate third side (65) should be parallel to the ground and the top retainer plate top surface (76) should be parallel to the surface of the suitable mounting area (96) to which the instant invention is mounted. Furthermore, the bottom retainer plate fourth side (66) must face toward the direction which the door or gate which is being secured, opens.

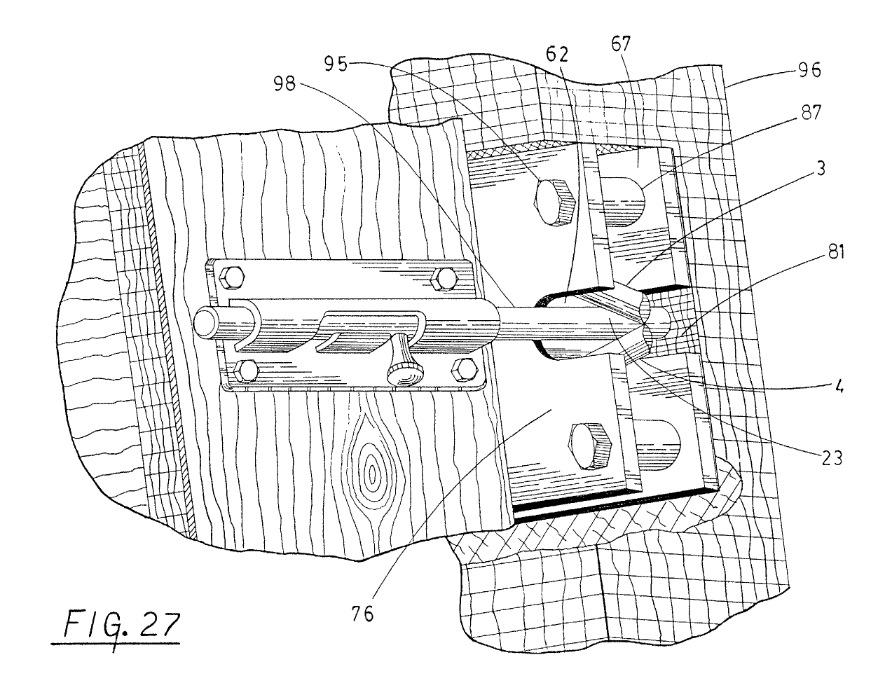

As per FIG. 26, a door latch (97) is then mounted to the door which is to be retained closed by the releasable safety connector. It is preferred to utilized the type of door latch which includes a cylindrical bolt (98). The door latch is attached to the door so that the door latch is proximate to the instant invention, in such a manner that the bolt may be slid into its locked position, and when so oriented, as per FIGS. 25, 26 and 27, the bolt (98) will extend through the top retainer plate slot (81), through the releasable safety connector open inner space (23) and through the bottom retainer plate slot (62).

With the bolt (98) secured between the first leg (3) and the second leg (4), the operation of the third embodiment is similar to the operation of the second embodiment, as per FIGS. 22, 23, and 24. However, where in the second embodiment it was the second snap hitch (24) which was pulled free of the releasable safety connector, in the third embodiment it is the bolt (98) performing the same function.

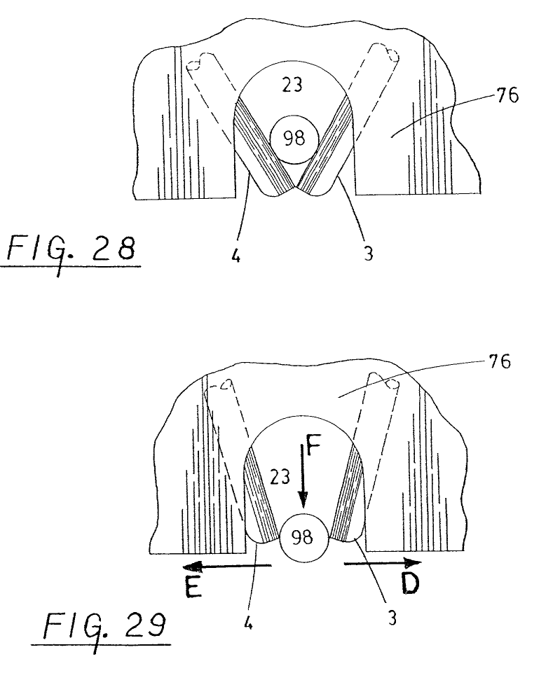

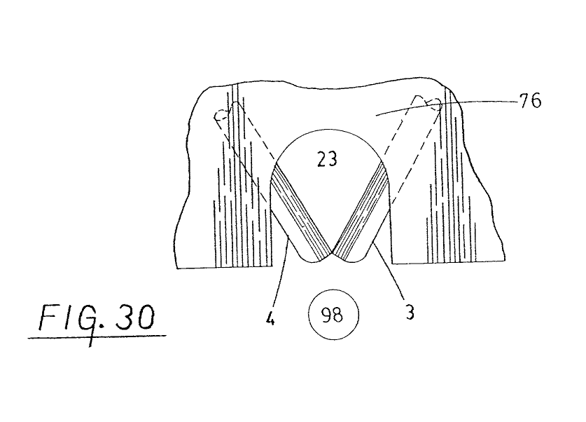

As per FIGS. 28, 29 and 30, the bolt (98) is lodged between the first leg (3) and the second leg (4) when the door is closed, and the latch is engaged. An animal attempting to open the door will push against the door, and the bolt will be pressed toward the open end (99) of the bottom retainer plate slot and the top retainer plate slot, in the direction of arrow “F”. However, because the terminating portion of the first leg and the terminating portion of the second leg are in close proximity to one another, the bolt can not pass between them and exit the open inner space (23). As the animal continues to apply pressure to the door, attempting to force the door open, the bolt (98) will force the first leg (3) away from the second leg (4), in the direction of arrow “D”. At the same time, the bolt will force the second leg (4) away from the first leg (3) in the direction of arrow “E”. As with the second embodiment, the first leg (3) and the second leg (4) will remain co-planar as they move away from one another.

If the animal exerts sufficient force against the door, in the direction of arrow “F”, the bolt (98) will spread the first leg and the second leg sufficiently apart so as to permit the bolt to exit the open inner space (23) and pass through the slot open end (99). The door will then be unlatched and the animal may freely exit. As with the second embodiment, once the bolt has cleared the first leg and the second leg, the two legs will return to their original positions with their terminating portions in close proximity to one another.

In yet another embodiment of the instant invention, the releasable safety connector is configured for use on both swinging and sliding doors. That is, where the immediately prior embodiment was most useful for doors which swing open, this embodiment can also be used on doors which do not pivot or swing, but rather slide (usually toward the right or toward the left of the user who is opening or closing the door.)

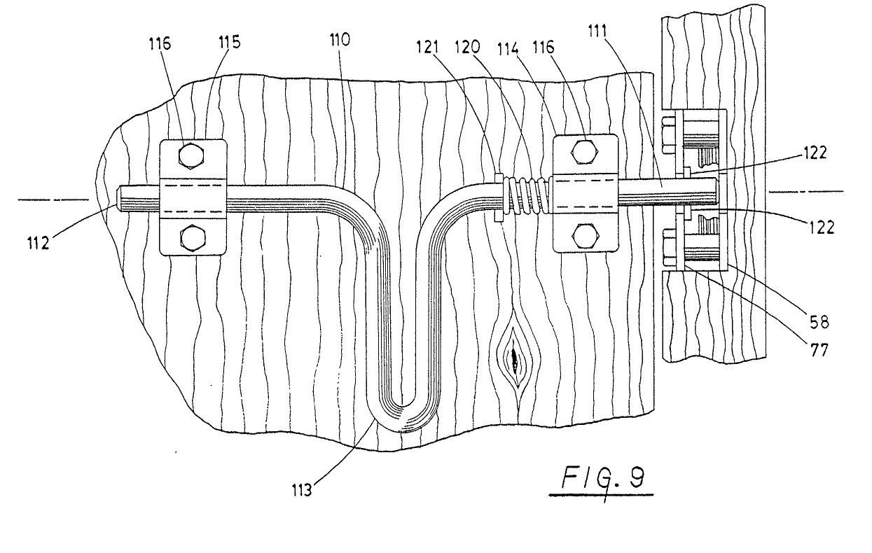

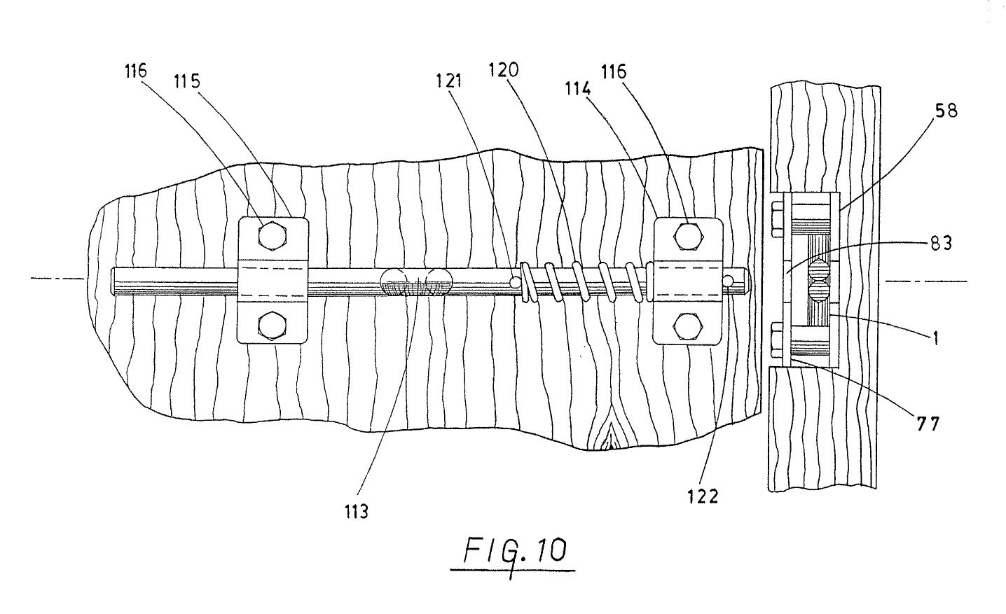

In this embodiment, the device may be mounted between two plates in the same fashion as was the previous embodiment. However, in place of a simple prior art sliding bolt mechanism a rotating and sliding bolt mechanism having means for biasing the bolt (120) is included. As per FIGS. 9 and 10, the rotating and sliding bolt is essentially a cylindrical bolt (110) having a first end (111), an opposite second and (112) a body (113) extending therebetween, the body preferably having a “U” shaped bend along its length, the bend serving as the handle for manipulating the bolt. This bolt is supported by and secured to the sliding door using securing means. The preferred securing means is composed of a first form fitting plate (114) and a second form fitting plate (115), the first and second form fitting plates each having retainer means for securing the plates and the bolt to the door. The form fitting plate is essentially generally rectangular plate having a “hump” or semi-cylindrical upwelled section which fits the form of the cylindrical bolt which it overlies when fully assembled. The preferred retainer means is a pair of holes passing through the plate for the admission therethrough of connector means (116) such as a threaded bolt or screw. As per FIG. 11, the bolt is further supported by and secured to the door by spacer means (117). The spacer means ensure that there is sufficient space between the bolt and the door to permit the bolt to operate in the manner set forth below. In the preferred embodiment, the spacer means are a pair of flat plates which are placed in direct contact with the door. Like the form fitting plates, the spacer means also include retainer means. In its simplest version, the spacer means retainer means are also a pair of holes (118) passing therethrough. When fully assembled, the spacer means and the form fitting plates serve to sandwich the bolt therebetween. With the bolt securely, but movably (that is, slidably and rotatably) mounted between the spacer means and the form fitting plates, the bolt may be attached to the door. This is most easily accomplished by axially aligning the retainer means passing through the spacer means with the adjacent retainer means passing through the form fitting plates, then passing a single connector means through the aligned retainer means and securing the connector means into the sliding door. For example, one may easily align the holes, pass a screw through each (a total of four screws is preferred), and twist the screws so they pull themselves into the door.

Naturally, while the spacer means and the form fitting plates have been described as individual elements, it is perfectly acceptable to manufacture those elements as a single piece, and then thread the bolt through the opening defined by the front portion (form fitting plate) and the back portion (spacer plate).

While the spacer plate has been described as being “flat”, it should be understood that it must have thickness (119) sufficient for the bolt to operate in the manner set forth below.

It was indicated above that the bolt was to include a means for biasing that bolt. The Inventors prefer, as per FIGS. 9 and 10 for that biasing means to be a spring.

When configured in the manner described herein, it is further necessary for that biasing means to have in cooperation therewith a spring retention means (121) against which the spring may load when in use. This is most easily accomplished by having the bolt include a pair of oppositely aligned holes with a bore therebetween so that a rod may be inserted, radially, through the bolt (in one of the holes, through the bore, and out the oppositely aligned hole). The inventors prefer that the spring retention means (121) be located between the first end (111) and the preferably “U” shaped portion of the bolt body (113), more proximate to the “U” shaped portion than the first end. The bore and rod should be so closely fitting with one another that rod may be securely, and preferably permanently, inserted therethrough. In the alternative, one could just as easily secure the rod within the bore using adhesives, bonding agents or welding.

As was noted, the Inventors prefer to use a spring as the means for biasing the bolt. It is preferred to use a spring of the coil type, having a central opening extending radially outward from and along its axis. It is this central opening through which the bolt will pass when fully assembled. During assembly, the rod is securely lodged within the bore, and the bolt is passed through the central opening of the spring such that the spring may be brought into contact with the rod. Obviously, the length of the rod must be such that once securely engaged within the bore, the rod cannot pass within or through the central opening of the spring. Instead, the rod acts as a stop or base against which the spring may press during compression of the spring.

Furthermore, the spring must have a greater outside diameter than opening defined by the front portion (form fitting plate) and the back portion such that when the bolt is threaded through that opening, the spring cannot pass within or through that opening. The combination of the form fitting plate with its spacer plate at one end of the spring, and the rod passing through the bolt at the other end of the spring, together and in concert function as the means for biasing the bolt.

As per FIGS. 9 and 10, the bolt further has a latch retention means (122). It is preferred that the latch retention means be essentially the same as the retention means cooperating with the spring. Like the retention means cooperating with the spring, the latch retention means is most easily accomplished by having the bolt include a pair of oppositely aligned holes with a bore therebetween so that a rod may be inserted, radially, through the bolt (in one of the holes, through the bore, and out the oppositely aligned hole), proximate to the first end of the bolt. The bore and rod should be so closely fitting with one another that rod may be securely, and preferably permanently, inserted therethrough and retained therein. In the alternative, one could just as easily secure the rod within the bore using adhesives, bonding agents or welding.

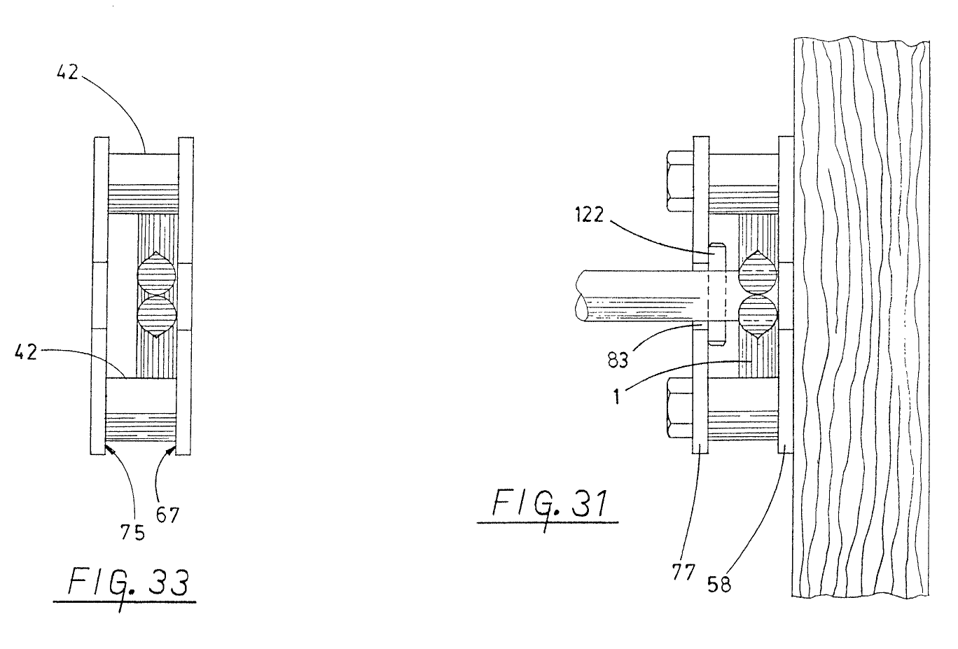

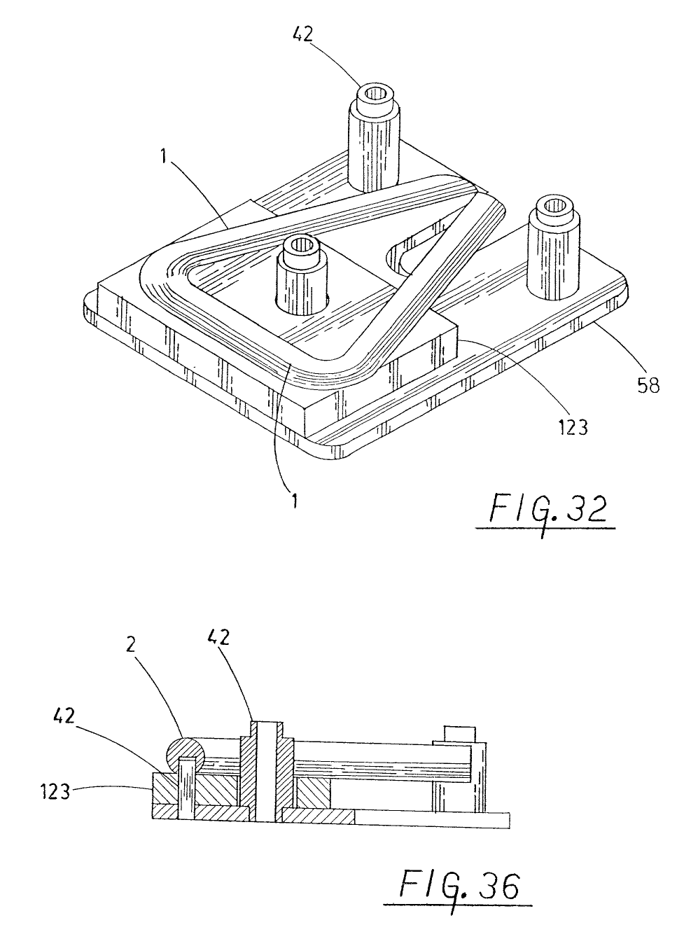

When practicing this embodiment of the instant invention, as per FIGS. 9, 10, and 31 the releasable safety connector (1), is sandwiched between the bottom retaining plate (58) and the top retaining plate (77) such that the releasable safety connector is not in direct contact with the top retaining plate. That is, as per FIGS. 32, 33 and 34 the releasable safety connector (1) is spaced apart from the top retaining plate bottom surface (75). This spacing apart permits the latch retaining means (122) to operate more efficiently when the device is in use.

The spacing apart of the top retaining plate may most easily be accomplished using the more complex stand offs (42) as set forth above, and preferably with the further inclusion of a latch spacing plate (123) as per FIG. 32. The latch spacing plate is simply a generally rectangular block of hard and rigid material (such as steel or iron or the like) which is placed -in direct contact with the top retaining plate bottom surface prior to assembly of the device, and upon which the releasable safety connector is attached. In this manner, the releasable safety connector may be spaced apart from the top retaining plate. This is just as easily accomplished by the inclusion of the more complex stand offs as per FIGS. 8 and 35, the stand offs having sufficient height (124) so that once the top retaining plate bottom surface is place in contact with the stand offs, the top retaining plate bottom surface is spaced apart from the releasable safety connector.

In it's simplest manifestation, the latching space plate is simply permanently attached to the top retaining plate by welding, gluing or similar permanent attachment means, and a stand off is permanently attached to the side of the latch spacing plate opposite the side of the latch spacing plate which is in contact with the top retaining plate bottom surface. The releasable safety connector may then be permanently attached to the latch spacing plate such that it is in direct contact with the same side of the latch spacing plate as is the stand off, the stand off being located within the space between the first leg, second leg and midsection, more proximate to the midsection. Finally the bottom retaining plate top surface may be permanently attached to the stand offs.

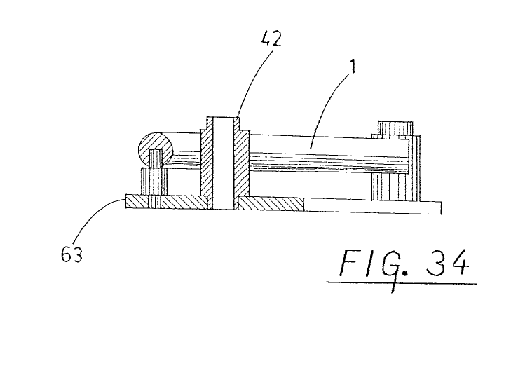

In another alternative, as per FIGS. 34 and 35, one may use five stand offs to accomplish the same spaced apart connections between the top retaining plate and the releasable safety connector. Furthermore, in this configuration, the device may be assembled in a semi-permanent fashion so that it is possible to take it apart for purposes of utilizing different releasable safety connectors requiring different amounts of force to separate the two legs from one another.

In this alternative, the top retaining plate has a total of five holes passing therethrough, one for each stand off. The bottom plate has only three holes passing therethrough for stand offs, as did the third embodiment. Additionally, the latch spacing plate has a pair of holes corresponding to two of the holes found on the top retaining plate. Additionally, the releasable safety connectors has a pair of blind holes on that side of the releasable safety connector which will be in contact with the latch spacing plate.

As per FIGS. 34 and 35, two of the holes passing through the top retaining plate are generally proximate to the bottom plate first side (63), when fully assembled. A more complex stand off is inserted removably into each of these holes. These particular more complex stand offs may be completely solid as nothing need be passed through them.

As per FIGS. 34, 35 and 36, the latch spacing plate (123) having the two corresponding holes is then placed in contact with the top retaining plate bottom surface by inserting the two corresponding stand offs (the two proximate to the first side) through the latch spacing plate holes. These stand offs should have sufficient height (124) so that they pass through the latch spacing plate, and emerge out of it. Next, the releasable safety connector is placed in direct contact with the latch spacing plate such that the two stand offs emerging through the latch spacing plate are inserted into the corresponding blind holes (125) on the releasable safety connector. The depth of the blind holes (that is, the depth of the bore associated with each hole, each bore obviously being blind) and the shouldered sections of the two stand offs should be such that the stand offs do not bottom out in the blind holes until the releasable safety connector is in direct contact with the latch spacing plate, as per FIG. 32.

Finally, the bottom retaining plate is attached such that the remaining three stand offs are inserted into the three corresponding holes in the bottom retaining plate. The bottom retaining plate may be in direct contact with the releasable safety connector, but does not have to be. Furthermore, the bottom retaining plate may include a slot (62), but need not in order to function.

Obviously, with the intention being to make the assembled device amenable to disassembly, it is best to have each of the holes passing through the bottom retaining plate, the bottom retaining plate, and the latch spacing plate, as well as the blind holes in the releasable safety connector be sized such that the corresponding stand off may be inserted firmly, but removably therein. The assembly should be firm enough so that it will not accidentally disassemble during use, but not so firm such that it is impossible to pull the various components apart.

The operation of the embodiment most useful in connection with sliding and swinging doors may now be better understood. As per FIGS. 9 and 10, the fully assembled latch mechanism (comprising the releasable safety connector, top retaining plate, bottom retaining plate, stand offs and latch spacing plate) is attached to a solid surface similarly to the manner in which the latch mechanism most useful in connection with swinging doors is. The more complex stand offs may be hollow in order to accommodate the passage therethrough of latch attachment means such as screws with may be used to fasten the latch mechanism to the solid surface. The bolt is assembled onto the sliding or swinging door in the manner set forth above.

The user of the device then manipulates the handle extending from the bolt such that the latch retention means (122) and the spring retention means (121) are oriented such that they are axially perpendicular to the surface upon which the bolt is mounted. Obviously, the length of the latch retention means and spring retention means (in this embodiment, both being a rod) must be such that the bolt may be freely rotated without the latch retention means and the spring retention means coming into contact with the surface upon which the bolt is mounted. It should be further obvious that the length of the latch retention means and the spring retention means may be increased by simply increasing the thickness of each of the pair of spacer plates used while attaching the bolt to the surface upon which it is to be mounted.

The latch retention means and the spring retention means now being axially perpendicular to the surface upon which the bolt is mounted, the bolt is slid toward the releasable safety connector which is sandwiched between the top retaining plate and the bottom retaining plate. The bolt first end (111) is passed through the top retaining plate slot (81) and brought through the open inner space (23) between the first leg (3) and the second leg (4). The latch retention means will be located in the spaced apart area between the top retaining plate top surface and the releasable safety connector, but will not be inserted so far into the latch so that the latch retention means enters the open inner space between the first leg and the second leg.

Finally, the user will once again manipulate the handle in order to rotate the bolt, (preferably in the opposite direction from that just previously rotated) such that the latch retention means and the retention means cooperating with the spring are once again axially parallel to the surface upon which the bolt is mounted.

It is well to remember now that the bolt mechanism includes means for biasing the bolt (120). This tends to bias the bolt away from the releasable safety connector at this point in time. That is, the bolt will tend to disengage from the releasable safety connector unless prevented from so doing. Therefore, it should be obvious that the latch retention means (122) should be of sufficient length so that once in the latched position (that is, being axially parallel to the surface upon which the bolt is mounted) the bolt is prevented from being moved away from the releasable safety connector by exiting the top retaining plate slot (81). Prevention of disengagement is most easily accomplished by preferably using the rod as the latch retention means and ensuring that the length of the rod is greater than the top retaining plate slot width (81), as per FIGS. 14 and 31. The biasing force (away from the bottom retaining plate top surface and in the direction of toward the top retaining plate bottom surface) serves to lodge the latch retention means against the top retaining plate bottom surface (75), and tends to keep the first end of the bolt located in the open space between the first leg and second leg.

Finally, the bolt may be disengaged from the releasable safety connector either by reversing the order of manipulating the bolt as set forth above, or by sufficient force being directed against the door or gate upon which the bolt is mounted, from within the stall or room which the door or gate encloses. That is, the bolt first end may be forced against the first leg and the second leg, spreading the legs apart and exiting the releasable safety connector in the same basic manner as that set forth in detail above in the disclosure of the embodiment most useful in connection with a swinging type door.

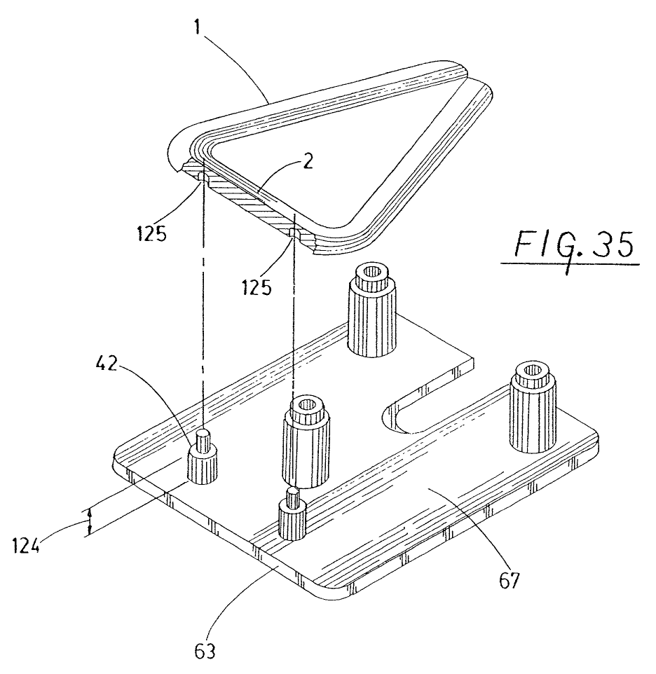

In a final embodiment of the instant invention, an adjustable force bar (200) is incorporated to vary the amount of force required to spread apart the first leg (3) from the second leg (4). As per FIG. 37, the adjustable force bar is most useful in connection with an embodiment of the releasable safety connector wherein the first leg and the second leg each include a section (201) which is not tangentially opposed to the other, but rather is parallel. In such a configuration, the first leg extends from the mid section linearly before angling toward the second leg. So too, the second leg extends from the midsection linearly before angling toward the first leg.

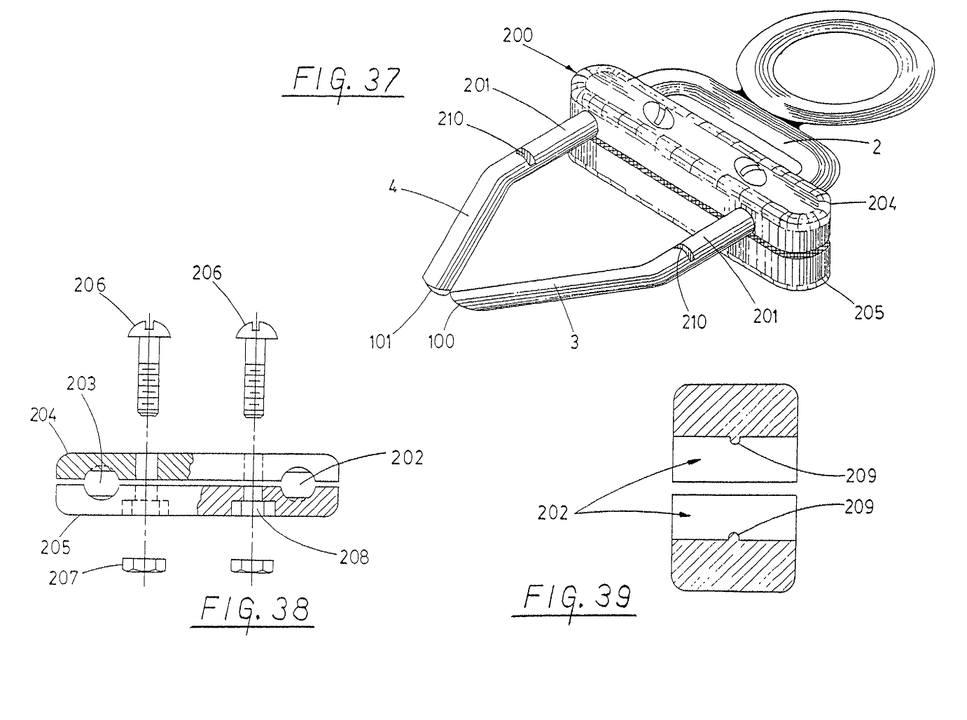

As per FIGS. 37 and 38, the adjustable force bar is an essentially linear body having a first leg passage (202) and a second leg passage (203). The first leg and the second leg may be inserted through the first leg passage and the second leg passage, respectively. The adjustable force bar may then be moved along the first leg and the second leg, bringing the adjustable force bar either closer to, or more distantly from, the midsection (2). The purpose of the adjustable force bar is to modify the force required to spread apart the first leg from the second leg. The closer the adjustable force bar is to the midsection, the less additional force is required to spread apart the first leg from the second leg. The closer the adjustable force bar is to the first leg terminating portion (100) and the second leg terminating portion (101), the more force is required to spread the first leg apart from the second leg.

It is preferred that the adjustable force bar be of a two piece construction. That is, a first half (204) and a second half (205). When assembled onto the releasable safety connector, the first half and the second half together would have a first leg passage and a second leg passage, each passage having an axis. The first leg passage and the second leg passage are each preferably a tubular bore of dimensions sufficient to permit the passage therethrough of the first leg and the second leg, respectively. When disassembled, the first half would have a portion of the tubular bore and the second half would have the remaining portion of the tubular bore. The first half and the second half may be easily detachably connected to one another by adjustable force bar connector means (206) passing therethrough. For example, one could include in the adjustable force bar a pair of connector means passages, the connector means passages being axially perpendicular to the each of the first leg passage axis and the second leg passage axis. When fully assembled onto the releasable safety connector, the connector means passage axis would be perpendicular to the first leg passage axis, the second leg passage axis, the first leg axis, the second leg axis and the midsection axis. The first leg axis being co-axial with the first leg passage axis, and parallel to and co-planar with the second leg passage axis.

The first half and the second half may then be easily connected to one another by assembling the first half and the second half around the first leg and the second leg, inserting a connector means such as a bolt through the each of the connector means passages, and completing the attachment of the first half and the second half to one another by threading a nut (207) onto the bolt. If so desired, the connector means passages may each be shouldered (208) such that the nut may be threaded onto the bolt so far as to have the nut flush with the surface of the second half.

By tightening the connector means sufficiently, the first half and the second half will tightly grip the first leg and the second leg such that the adjustable force bar cannot be slid along the legs when in use.

However, it is further possible to more precisely regulate the force required to spread the first leg apart from the second leg when the adjustable force bar is in use. As per FIG. 39, this may easily be accomplished by including a passage tab (209) within the first leg passage and the second leg passage, the passage tabs extending into the leg passages and being oriented transaxially relative to the leg passages. That is, the passage tabs extend from the adjustable force bar body, into the leg passages, somewhat obstructing the passages.

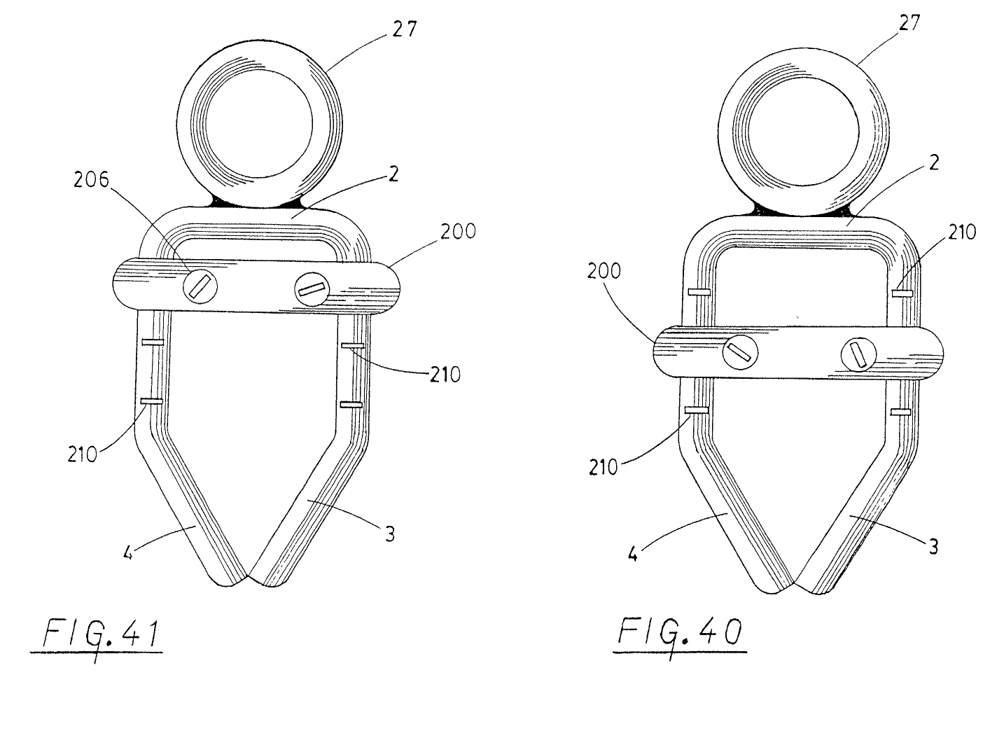

When such passage tabs are included, it is necessary to include corresponding grooves (210) on the first leg and on the second leg. As per FIGS. 37 and 40 the grooves are located on the first leg and the second leg. As per FIGS. 39, 40 and 41, when the adjustable force bar is of the type having a first half and a second half, the passage tabs on the first half are aligned with the grooves on the first leg and the second leg. The passage tabs on the second half are then aligned with the corresponding grooves on the first leg and the second leg. The first half and the second half are then connected to one another using the connecting means. The passage tabs are thereby firmly seated into the grooves, and insure that the force bar will not move along the first leg and the second leg during use.

Furthermore, it is possible to include a series of grooves along the first leg and the second leg, the placement of the grooves at set distances from the midsection providing for easily repeatable placement of the adjustable force bar. In such a case, as per FIGS. 40 and 41, the adjustable force bar (200) may be very easily located along the first and second leg at different distances from the midsection, thereby assuring a better connection between the adjustable force bar and the releasable safety connector, as well as permitting greater and repeatable adjustability of the force required to spread apart the first leg from the second leg.

I claim:

1. A releasable safety connector comprising;
A. a first leg and a second leg,
B. leg intermediate means,
I. the first leg being attached to the leg intermediate means,
II. the second leg being attached to the leg intermediate means,
III. the first leg and the second leg being tangentially opposed to one another,
IV. the first leg and the second leg being biased towards one another.

2. A releasable safety connector according to claim 1 further comprising;
A. the leg intermediate means being a midsection having a first end and a second end,
B. the first leg having a first end and a second end,
I. the first end being attached to the midsection first end,
C. the second leg having a first end and a second end,
I. the end being attached to the midsection second end,
II. the second leg being co-planar with the first leg and the midsection.

3. A releasable safety connector according to claim 1 further comprising;
A. the leg intermediate means being a retainer ring.

4. A releasable safety connector according to claim 2 further comprising;
A. the midsection, first leg and second leg together being triangular in form.

5 A releasable safety connector according to claim 1 further comprising;
A. the leg intermediate means being a midsection,
B. a retainer ring,
I. the retainer ring being attached to the midsection.

6. A releasable securing mechanism comprising;
A. a bottom retainer plate,
B. a top retainer plate,
I. the top retainer plate being indirectly attached to and spaced apart from, the bottom retainer plate.
B. a releasable safety connector,
I. the releasable safety connector being sandwiched between the bottom retainer plate and the top retainer plate.

7. A releasable securing mechanism according to claim 6 further comprising;
A. a siding bolt mechanism for cooperating with the bottom retainer plate, top retainer plate, and releasable safety mechanism.

8. A releasable securing mechanism according to claim 7 further comprising;
A. the bottom retainer plate having a cut out,
B. the top retainer plate having a cut out,
C. the releasable safety connector having a leg intermediate means spanning between a first leg and a second leg,
I. the first leg and the second leg being tangentially opposed to one another,
II. the first leg and the second leg having a space between them,
III. the space between the first leg and the second leg overlapping the bottom retainer plate cut out and the top retainer plate cut out.

9. A releasable securing mechanism according to claim 7 further comprising;
A. the releasable safety connector being attached to the bottom retainer plate.

10. A releasable securing mechanism according to claim 7 further comprising;
A. stand offs,
I. the stand offs being intermediately attached to the first retainer plate and the second retainer plate.

11. A releasable securing mechanism according to claim 7 further comprising;
A. the bottom retainer plate having retainer holes,
I. the retainer holes being sized and shaped for insertion therethrough of plate retainer means.

12. A releasable securing mechanism according to claim 7 further comprising;
A. the bottom retainer plate having retainer holes,
B. the top retainer plate having retainer holes,
I. the top retainer plate retainer holes and the bottom retainer plate retainer holes being co-axially aligned,
a. the retainer holes being sized and shaped for insertion therethrough of plate retainer means.

13. A releasable securing mechanism according to claim 12 further comprising;
A. standoffs,
I. the stand offs being intermediately attached to the first retainer plate and the second retainer plate,
II. the stand offs having a hollow interior sized and shaped for the passage therethrough of the plate retainer means,
III. the stand offs being co-axially aligned with top retainer plate holes and the bottom retainer plate holes.

14. A releasable securing mechanism according to claim 6 further comprising;
A. the top retainer plate having a cut out,
B. the releasable safety connector being spaced apart from the top retainer plate,
B. a rotating and sliding bolt mechanism for cooperating with the top retainer plate and releasable safety connector.

15. A releasable securing mechanism according to claim 14 further comprising;
A. a latch spacing plate,
I. the latch spacing plate being proximate to the top retainer plate,
II. the releasable safety connector being proximate to the latch spacing plate and the bottom retainer plate,
III. the latch spacing plate spacing apart the top retainer plate from the releasable safety connector,
B. standoffs,
I. the stand offs contacting the bottom retainer plate and the top retainer plate and indirectly attaching the top retainer plate and the bottom retainer plate.

16. A releasable securing mechanism according to claim 14 further comprising;
A. the rotating and sliding bolt mechanism having a bolt,
I. the bolt having a first end, an opposite second and a body extending therebetween,
II. the bolt having a latch retention means proximate to the first end,
III. the bolt having a spring retention means,
B. the rotating and sliding bolt mechanism having a first form fitting plate and a second form fitting plate for retaining the rotating and sliding bolt mechanism upon a surface to which it is mounted,
I. the first form fitting plate being located distally from the bolt second end,
C. the rotating and sliding bolt mechanism having spacer means,
I. the bolt being sandwiched between the form fitting plates and the spacer means,
D. the rotating and sliding bolt mechanism having a means for biasing the bolt.

17. A releasable securing mechanism according to claim 16 further comprising;
A. the means for biasing the bolt being located between the first form fitting plate and the spring retention means.

18. A releasable safety connector comprising;
A. a first leg and a second leg,
B. leg intermediate means,
I. the first leg being attached to the leg intermediate means,
II. the second leg being attached to the leg intermediate means,
III. the first leg and the second leg being tangentially opposed to one another,
IV. the first leg and the second leg being biased towards one another,
C. an adjustable force bar,
I. the adjustable force bar having a first leg passage and a second leg passage,
a. the first leg passage being sized and shaped for insertion therethrough of the first leg,
b. the second leg passage being sized and shaped for insertion therethrough of the second leg.

19. A releasable safety connector according to claim 18, the adjustable force bar further comprising;
A. a first half and a second half,
B. connector means for attaching the first half to the second half.

20. A releasable safety connector according to claim 18 further comprising;
A. at least one passage tab located within the first leg passage or the second leg passage, or both the first leg passage and the second leg passage,
B. at least one groove located on the first leg or the second leg, or both the first leg and the second leg,
I. the groove being sized and shaped for firm seating of the passage tab therein.
